(19) United States
(12) Patent Application Publication
(10) Pub. No.: US 2024/0299815 A1
(43) Pub. Date: Sep. 12, 2024

(54) ONE-TIME SINTERING PREPARATION PROCESS FOR METAL INJECTION MOLDING OF GOLF HEAD WITH DUAL METAL COMPONENTS

(71) Applicant: MATRIX (Guangzhou) Metamaterials Co., Ltd., Guangzhou (CN)

(72) Inventors: Liqun YI, Guangzhou (CN); Fei XIAO, Guangzhou (CN); Guangxing DENG, Guangzhou (CN); Xiaohua TIAN, Guangzhou (CN)

(21) Appl. No.: 18/313,599

(22) Filed: May 8, 2023

(30) Foreign Application Priority Data
Mar. 9, 2023 (CN) 202310221232.9

(51) Int. Cl. A63B 53/04; B22F 3/10

(52) U.S. Cl. CPC A63B 53/047; B22F 3/1007; A63B 2102/32; A63B 2209/00; B22F 2201/013; B22F 2201/02; B22F 2301/355

(57) ABSTRACT

The present disclosure relates to the technical field of material processing, and particularly provides a preparation process for a golf head with dual metal components. The molded tungsten alloy injection blank is embedded into a stainless steel injection molded mould, the stainless steel feed and the tungsten alloy injection blank are subjected to injection molding to obtain an integrated injection blank subjected to in-mould injection molding, and the golf head with dual metal components is prepared by degreasing and sintering. The preparation process of the present disclosure is applied to golf heads required for counterweight assembling, is completed by using one-time degreasing and sintering process after injection molding of dual metals so as to break through the limitation of a metal injection molding (MIM) technology that can only produce one metal part once, and can be used for one-time molding of stainless steel and tungsten alloy metal parts.

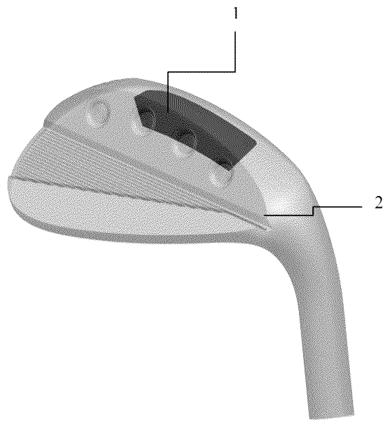

### TECHNICAL FIELD

The present disclosure relates to the field of material processing, in particular to a one-time sintering preparation process for metal injection molding of a golf head with dual metal components.

### BACKGROUND

A golf head often includes two components, i.e., a conventional metal main body (stainless steel and low alloy steel) and a high specific gravity metal counterweight (tungsten alloy). For example, the high specific gravity metal counterweight mounted at the bottom of an iron rod or a sand rod may enlarge the rotational inertia during the swing and increase the hitting distance; and the high specific gravity counterweights mounted at both sides of a push rod may reduce the swing and increase the stability when pushing the ball. The current production method is that the two different components are respectively produced by using different processes (such as precise casting, forging, CNC (Computer Numerical Control) machining and powder metallurgy), and then assembled by welding, nut fixing, riveting and other methods.

The existing golf head metal processing process has the defects of long technological process, large environmental protection pressure, many steps, high production cost, long production period and the like, specifically including the following manifestations:
(a) the precise casting needs to first fabricate a mould case with a drying cycle of about 10 days and a full production cycle of about 15 days; the fabrication of the mould case produces a large amount of sand powder solid wastes, with large environmental protection pressure; the working environment is harsh, and high temperature and dust cause occupational health problems; the casting part has a rough surface, and the post machining and polishing cost is high; and the porosity inside the casting part leads to a low yield;
(b) the forging is high in cost and low in production capacity, needs single forging, and therefore cannot meet the customer's demand; parts with complicated structures cannot be produced; and after forging, the machining allowance is large, so CNC machining cooperation is needed, with high cost; and
(c) CNC machining has minimum production capacity, CNC equipment takes 1-2 hours to machine one golf head, and therefore lots of investments are needed to purchase equipment so as to meet the demands, and a large number of labor is also required.

Parts with two different metal components are used to assemble the golf head. At present, a conventional specific gravity metal main body and a high specific gravity tungsten alloy counterweight are manufactured separately and then assembled together. The assembling process includes welding, screwing, riveting and the like, with many steps. Furthermore, the tungsten alloy is prone to crack or even crush during the production and use due to poor roughness and easy brittle rupture.

Metal injection molding (MIM) based on a powder metallurgy technology has been a mature process for producing golf heads. MIM can be used for producing a main body component of a golf head or a tungsten alloy counterweight component. However, in the MIM process, the two metal materials have differences and therefore must be separately produced and then assembled together. These differences include but are not limited to: (a) different sintering temperatures, that is, the sintering temperature of the tungsten alloy is above 1400° C., and the sintering temperatures of the stainless steel and the low-alloy steel are 1200° C.-1380° C.; (b) different sintering shrinkage ratios, that is, a shrinkage ratio of the tungsten alloy is 1.20 or more, and the shrinkage ratios of the stainless steel and the low-alloy steel are 1.165-1.216; and (c) different sintering atmospheres, that is, the tungsten alloy needs to be sintered at normal pressure under the protection of hydrogen or an inert gas, and the stainless steel and the low-alloy steel need to be sintered in vacuum under the production of an inert gas.

### SUMMARY

The objective of the present disclosure lies that to solve the above disclosure problems, the present disclosure combines tungsten alloy powders to obtain powders that can be subjected to injection molding and a series of follow-up operations in a stainless steel mould.

The core of the present disclosure is that the shrinkage ratios of the tungsten alloy and the stainless steel are unified by adjusting proportions of stainless steel and tungsten alloy so that their shrinkage ratios are identical, the tungsten alloy and the stainless steel can be embedded together through an in-mould injection process to obtain a golf head with high molding rate and excellent quality that can be prepared through in-mould injection molding and a one-time sintering process.

The technical solution of the present disclosure is as follows:

The present disclosure provides a golf head with dual metal components, where preparation raw materials include tungsten alloy, stainless steel and a binder; the mass content of tungsten in the tungsten alloy is 30-99%, and the content of other alloy components is 0-20%; the stainless steel is one of an iron-based raw material, 304 stainless steel, 316 L stainless steel and 17-4 PH stainless steel.

The other alloys of the present disclosure include the following components in parts by weight: 4-15 parts by weight of nickel and 2-10 parts by weight of copper/iron.

As a further study, a weight part ratio of the tungsten alloy powder to the stainless steel powder is 1:40-1:20.

As a further study, the stainless steel powder is proportional to the binder in a weight part ratio of 1-3:0.4-0.8.

As a further study, a method for preparing the golf head includes the following steps:
Step 1: respectively feeding and proportioning tungsten alloy and stainless steel powders with a sintering agent;
Step 2: performing one-time injection molding on tungsten alloy feed to obtain an in-mould injection molded insert, then putting the insert into a mould with stainless steel feed for in-mould injection molding to obtain an injection blank in which the tungsten alloy feed is wrapped with the stainless steel feed;
Step 3: performing three-step degreasing on the blank; and
Step 4: sintering the degreased blank at a temperature of 1380-1420° C. under a nitrogen and hydrogen mixed atmosphere at a pressure of 40-50 Kpa to obtain a sintering product of a golf head with dual metals.

As a further study, in Step 2, a plasticizing temperature of the injection molding process is 180° C.-220° C., a heating temperature of the mould is 90° C.-120° C., and an injection pressure is 110-130 MPa.

As a further study, a density of the tungsten alloy is 8-9 g/cm³ before sintering, and 14-15 g/cm³ after sintering.

As a further study, the three-step degreasing in Step 3 is as follows: the blank is pre-rinsed and then placed in a degreasing furnace to be degreased for 13-22 h under a nitrogen atmosphere at a nitrogen flow rate of 0.8 L/min at the temperature of 100° C.-140° C., and then the degreased blank is rinsed again to obtain a preliminarily molded golf head crude product.

As a further study, the sintering process in Step 4 is divided into three steps, including negative pressure degreasing, vacuum sintering and partial pressure sintering, respectively.

As a further study, the sintering agent includes the following compositions: 90% of polyformaldehyde, 3% of ethylene copolymer, 4% of ethylene propylene diene monomer rubber, 1% of glyceryl stearate, 1% of 2,6-di-tert-butyl-4-methylphenol and 1% of high-density polyethylene (HDPE).

The present disclosure has the beneficial effects: the present disclosure provides a preparation process of a golf head with dual metal components, which is completed using a one-time degreasing and sintering process after injection molding of dual metals. First, one of the metals, tungsten alloy, is subjected to injection molding, and the injection blank of the molded tungsten alloy is embedded into the mould for stainless steel injection molding, the injection blank of the stainless steel feed and the tungsten alloy is subjected to injection molding to obtain an integrated injection blank subjected to in-mould injection molding, and the golf head with dual metal components is prepared through degreasing and sintering. The preparation process of the present disclosure is applied to golf heads with high counterweight assembling requirements, which is completed using a one-time degreasing and sintering process after injection molding of dual metals so as to break through the limitation of a metal injection molding (MIM) technology that can only produce one metal part once, and can be used for one-time molding of stainless steel and tungsten alloy metal parts, and has the advantages of fewer production steps, short construction period, low cost and the like. The prepared golf head has a good appearance, and high toughness without cracking

### BRIEF DESCRIPTION OF THE DRAWINGS

The figure is a structural diagram of a golf head with dual metal components; where 1—high specific gravity tungsten alloy; 2—stainless steel

### DETAILED DESCRIPTION OF THE EMBODIMENTS

### Example 1

This example provides a golf head with dual metal components. The preparation raw materials included tungsten alloy, stainless steel and a binder; the tungsten alloy included the following components in percentage by weight: 80% of tungsten, 15% of copper and 5% of nickel; the stainless steel was 17-4 PH stainless steel.

A weight part ratio of the tungsten alloy powder to the stainless steel powder was 1:20.

The stainless steel powder was proportional to the binder in a weight part ratio of 3:0.8.

A method for preparing a golf head in this example comprised the following steps:

Step 1: tungsten alloy and binder powders were mixed internally and underwent injection molding to form a one-time injection molded blank;

Step 2: feed formation: stainless steel metal powders were preheated to 180° C. and stirred at a rotation speed of 15 r/min; a binder was added, the binder and the stainless steel metal powders were internally mixed for 2.5 h at 180° C., and then cooled to 160° C. and continued to be internally mixed for 2 h while stirring at the rotation speed of 45 r/min; granular feeds were obtained by extruding and pelleting after internal mixing was completed.

The used binder mainly included the following components: 90% of polyformaldehyde, 3% of ethylene copolymer, 4% of ethylene propylene diene monomer rubber, 1% of glyceride stearate, 1% of 2,6-di-tert-butyl-4-methylphenol, 1% of high density polyethylene (HDPE) (formulation of a binder for metal injection molding in example 9 authorized by CN2018108977446).

Step 3: tungsten alloy and binder powders were mixed internally and underwent injection molding to form a one-time injection molded blank, 304 stainless steel powders were prepared into a feed for one-time injection molding, the 304 stainless steel together with the injection molded tungsten alloy blank was put into an injection molding machine for injection molding again, then the two metals were integrated into a mould to obtain a golf head blank with dual metals, wherein the case material was 304 stainless steel, and embedded into the tungsten nickel iron alloy counterweight;

The in-mould injection molding conditions of the dual metals were as follows: the temperature of the injection molding was 210° C., and the heating temperature of the mould was 120° C., the injection pressure was 130 MPa, and the golf head blank with dual metals, i.e., one-time injection molded blank, was obtained by injection molding.

Step 4: the injection molded golf head blank with dual metals was degreased and sintered, namely, the blank was pre-rinsed and then placed in a degreasing furnace to be degreased for 22 h under the atmosphere of nitrogen at 120° C., and then the degreased blank was rinsed, where the parameters of the degreasing and sintering were as follows: the temperature in the degreasing furnace was 130° C., the flow of nitrogen was 0.8 L/min, and the degreasing time was 24 hours. The temperature in the sintering furnace was 1380° C., the sintering time was 24 hours, the sintering was directly performed under the atmosphere of nitrogen instead of hydrogen atmosphere required for sintering of tungsten alloy at the pressure of 40 Kpa, and then a injection molded golf head crude product with dual metals;

an injection molded golf head finished product with dual metals was finally obtained by posttreatment procedures such as polishing and sand blasting.

### Example 2

This example provides a golf head with dual metal components. The preparation raw materials included tungsten alloy, stainless steel and a binder; the tungsten alloy included the following components in percentage by weight: 80% of tungsten, 15% of iron and 5% of nickel; the stainless steel was 304 stainless steel.

The weight part ratio of the tungsten alloy feeds to the stainless steel feeds was 1:30.

The stainless steel powder was proportional to the binder in a weight part ratio of 2:0.6.

The preparation method of the golf head in example 2 was the same as that in example 1.

### Example 3

This example provides a golf head with dual metal components. The preparation raw materials included tungsten alloy, stainless steel and a binder; the tungsten alloy included the following components in percentage by weight: 90% of tungsten carbide and 10% of iron; the stainless steel was 316 L stainless steel.

The weight part ratio of the tungsten alloy feeds to the stainless steel feeds was 7:2.

The stainless steel powder was proportional to the binder in a weight part ratio of 1:0.4.

The method for preparing the golf head in example 3 was the same as that in example 1.

### Comparative Example 1

Comparative example 1 is different from example 2 in that the tungsten alloy used in comparative example 1 includes the following components in percentage by weight: 89% of tungsten, 3.5% of copper and 7.5% of molybdenum.

### Comparative Example 2

Comparative example 2 is different from example 2 in that the stainless steel used in comparative example 2 is 410 stainless steel.

### Comparative Example 3

Comparative example 3 is different from example 2 in that the weight part ratio of the tungsten alloy powder to the stainless steel powder in comparative example 3 is 1:21.

### Comparative Example 4

Comparative example 4 is different from example 2 in that in comparative example 4, the stainless steel powder is proportional to the binder in a weight part ratio of 1:1.

### Comparative Example 5

Comparative example 5 is different from example 2 in that in comparative example 5, the plasticizing temperature of the injection molding process is 160° C., the heating temperature of the mould is 70° C., and the injection pressure is 90 MPa.

### Comparative Example 6

Comparative example 6 is different from example 2 in that the sintering temperature in comparative example 6 is 1280° C.

### Comparative Example 7

Comparative example 7 is different from example 2 in that the sintering temperature in comparative example 7 is 1480° C.

### Test Results

The yield of the injection molded golf head finished product with dual metals in examples was 94.0-97.0%; in comparative example 1, other tungsten alloy metal powders were adopted to obtain metal hollow powders, so the process is failed; the yields of the injection molded golf head finished products with dual metals in comparative examples 2-7 were 70%-85.0%. It can be seen from comparative examples 2-4 that in the present disclosure, the two metal feeds prepared by selecting the proportion of stainless steel metal components, the specific gravities of tungsten alloy and stainless steel, and the proportions of the binder and the stainless steel are more in line with a process integrated with injection molding, degreasing and sintering; it can be seen from comparative example 5 that only under the injection molding conditions selected in the present disclosure, the injection molded golf head blank with dual metals can be successively injected, with high integrating degree of two metals and low hollow rate; it can be seen from comparative examples 6-7 that the sintering temperature of the present disclosure is the optimal sintering condition.

The proportions of tungsten, nickel and iron used in examples reduce the density of the tungsten alloy, are matched with the compositions of the stainless steel alloy, increase the adhesion to the stainless steel alloy, and prevent the existence of voids between the tungsten alloy counterweight and the stainless steel metal case. The prepared tungsten alloy powder has a particle size ranging from 0.5 μm to 40 μm, and D50 ranging from 2.0 μm to 4.0 μm, the particle size of the stainless steel powder has a distribution interval of 2.62 μm-23.66 μm, D50 of 8.00 μm, a loose density interval of 3.10-3.20 g/cm³, and a tap density interval of 4.80-4.90 g/cm³. Compared with the stainless steel powder, the tungsten alloy powder has more fine and smooth particle size, the tungsten alloy blank takes longer time (22 hours) for subsequent degreasing and sintering, and the prepared finished product has better compactness.

The used tungsten alloy composition proportion, stainless steel metal composition proportion and the used binder as well as the ratio of the binder to the stainless steel to the tungsten alloy make the shrinkage ratios of the tungsten alloy and the stainless steel unified, and the specific gravity of the used tungsten alloy and stainless steel can adapt to process requirements of both Step E3 and Step E4.

In the injection molding process conditions used in Step 3, the integrating degree of two different metals is added on the basis of meeting the stainless steel metal injection molding.

The three-step degreasing used in Step 4 can thoroughly burn out the binder material with a low boiling point, with high degreasing efficiency.

The above results show that the tungsten alloy composition proportion, the stainless steel metal composition proportion, the specific gravities of the tungsten alloy and the stainless steel, the used binder formulation, and the ratio of the binder to the stainless steel to the tungsten alloy in the present disclosure make the two metals have the same shrinkage ratio, degreasing sintering temperature, and atmosphere requirements, and the in-mould injection molding process and the one-time sintering molding process can be used to produce the golf head with an extremely high finished product yield.

The models of the golf heads prepared in examples are as shown in the figure.

It should be finally noted that the above examples are only for illustrating the technical solution of the present disclosure, but not limiting the protective scope of the present disclosure. Although the present disclosure is described in detail with reference to preferred examples, a person of ordinary skill in the art should understand that modifications or equivalent replacements can be made to the technical solution of the present disclosure without departing from the essence and scope of the technical solution of the present disclosure.

What is claimed is:

1. A golf head with dual metal components, wherein preparation raw materials comprise tungsten alloy, stainless steel and a binder; the mass content of tungsten in the tungsten alloy is 30-99%, and the content of other alloy components is 0-20%; the stainless steel is one of an iron-based raw material, 304 stainless steel, 316 L stainless steel and 17-4 PH stainless steel.

2. The golf head with dual metal components according to claim 1, wherein the other alloy components comprise the following compositions in parts by weight: 4-15 parts by weight of nickel and 2-10 parts by weight of copper/iron.

3. The golf head with dual metal components according to claim 1, wherein a weight part ratio of the tungsten alloy powder to the stainless steel powder is 1:40-1:20.

4. The golf head with dual metal components according to claim 1, wherein the stainless steel powder is proportional to the binder in a weight part ratio of 1-3:0.4-0.8.

5. The golf head with dual metal components according to claim 1, wherein a method for preparing the golf head comprises the following steps:
step 1: respectively feeding and proportioning tungsten alloy and stainless steel powders with a sintering agent;
step 2: performing one-time injection molding on tungsten alloy feed to obtain an in-mould injected insert, then putting the insert into a mould with stainless steel feed for in-mould injection molding to obtain an injection blank in which the tungsten alloy feed is wrapped with the stainless steel feed;
step 3: performing three-step degreasing on the blank; and
step 4: sintering the degreased blank at a temperature of 1380-1420° C. under a nitrogen and hydrogen mixed atmosphere at a pressure of 40-45 Kpa to obtain a sintering product of a golf head with dual metals.

6. The golf head with dual metal components according to claim 1, wherein in Step 2, a plasticizing temperature of the injection molding process is 180° C.-220° C., a heating temperature of the mould is 90° C.-120° C., and an injection pressure is 110-130 MPa.

7. The golf head with dual metal components according to claim 1, wherein a density of the tungsten alloy is 8-9 g/cm³ before sintering, and 14-15 g/cm³ after sintering.

8. The golf head with dual metal components according to claim 1, wherein the three-step degreasing in Step 3 is as follows: the blank is pre-rinsed and then placed in a degreasing furnace to be degreased for 13-22 h undera nitrogen atmosphere at a nitrogen flow rate of 0.8 L/min at a temperature of 100° C.-140° C., and then the degreased blank is rinsed again to obtain a preliminarily molded golf head crude product.

9. The golf head with dual metal components according to claim 1, wherein the sintering process in Step 4 is divided into three steps, including negative pressure degreasing, vacuum sintering and partial pressure sintering, respectively.

10. The golf head with dual metal components according to claim 1, wherein the binder comprises the following compositions: 90% of polyformaldehyde, 3% of ethylene copolymer, 4% of ethylene propylene diene monomer rubber, 1% of glyceryl stearate, 1% of 2,6-di-tert-butyl-4-methylphenol, and 1% of high-density polyethylene (HDPE).
